(19) United States
(12) Patent Application Publication
(10) Pub. No.: US 2026/0254259 A1
(43) Pub. Date: Aug. 27, 2026

(54) ULTRA-WIDE VOLTAGE RANGE AUXILIARY POWER MODULE

(71) Applicants: UNIVERSITY OF TENNESSEE RESEARCH FOUNDATION, Knoxville, TN (US); HELLA CORPORATE CENTER USA, INC., Northville Township, MI (US)

(72) Inventors: Liyan Zhu, Knoxville, TN (US); Alan W. Brown, Canton, MI (US); Hua Bai, Knoxville, TN (US); Lukas Michael Keuck, Paderborn (DE)

(21) Appl. No.: 19/128,852

(22) PCT Filed: Nov. 30, 2022
(86) PCT No.: PCT/US2022/051324

§ 371 Date: May 9, 2025

(51) Int. Cl. H02J 7/34; B60L 50/60; H02M 1/00; H02M 1/14; H02M 3/335

(52) U.S. Cl. CPC H02J 7/342; B60L 50/60; H02M 1/0087; H02M 1/14; H02M 3/33573; H02M 3/33592; B60L 2210/12; H02J 2207/20

(57) ABSTRACT

An improved auxiliary power module for use with electric vehicles is provided. The auxiliary power module includes a reconfigurable dual active bridge converter for providing either of a voltage-fed input or a current-fed input to a primary-side full bridge. The auxiliary power module also includes a current-fed output port that integrates an interleaved buck stage and presents an ultra-wide voltage coverage. The auxiliary power module achieves low switching currents on the secondary-side of the dual active bridge converter with low current stresses on the output port, which reduces losses and the transformer turn ratio when compared to conventional topologies.

### FIELD OF THE INVENTION

The present invention relates to auxiliary power modules, and in particular, auxiliary power modules for electric vehicles having reconfigurable battery packs.

### BACKGROUND OF THE INVENTION

Auxiliary power modules are an integral aspect of the modern electric vehicle (EV). Auxiliary power modules bridge high-voltage propulsion systems with low-voltage auxiliary systems by stepping down a high-voltage DC bus voltage (e.g., 400V) to a low-voltage DC bus voltage (e.g., 12V) to power non-propulsion loads and to charge a low-voltage battery. With the increasing demands of fast battery charging, high-voltage propulsion systems are increasingly designed to 800V instead of 400V. To adapt to this trend, auxiliary power modules also face the challenge of accepting a much wider voltage range, particularly in EVs with a reconfigurable battery pack, that is, a battery pack operable at two or more voltages (e.g., 400V and 800V).

In addition to challenges associated with accepting an input voltage over a wide range, modern auxiliary power systems must provide a high output current. Due to the low output voltage, typically 6V to 16V, auxiliary power modules suffer from high current stresses on the low-voltage side of the internal step-down transformer. For example, a 3.5 kW output at 12V represents an output current up to 300 A. For commonly used topologies such as LLC converters and DAB converters, heavy current loads mean either high switching currents or an unpractically high voltage gain. While efforts have been made to achieve a two-stage converter that provides high power and a wide voltage gain, these converters have proven to be complex and costly.

Accordingly, there remains a continued need for a low-cost auxiliary power module for use with reconfigurable batteries. In particular, there remains a continued need for an auxiliary power module that provides a high power output over a wide range of input voltages with an improved voltage gain and low switching current stresses at the low-voltage side.

### SUMMARY OF THE INVENTION

An improved auxiliary power module for use with electric vehicles is provided. The auxiliary power module includes a reconfigurable dual active bridge converter for providing either of a voltage-fed input or a current-fed input to a primary-side full bridge. The auxiliary power module also includes a current-fed output port that integrates an interleaved buck stage and presents an ultra-wide voltage coverage. The auxiliary power module achieves low switching currents on the secondary-side of the dual active bridge converter with low current stresses on the output port, which reduces losses when compared to conventional topologies.

In one embodiment, the auxiliary power module includes a switch connected between an input port and a primary-side full bridge of a dual active bridge converter. The switch is moveable between a first switching state and a second switching state based on an input voltage and/or an output voltage. The switch is optionally a double-throw relay that is configured to couple the input port to a first terminal or a second terminal corresponding to the first switching state and the second switching state, respectively. The primary-side full bridge receives a voltage-fed input when the switch is in the first switching state and receives current-fed input when the switch is in the second switching state. The primary-side full bridge is parallel-connected to the input port in the first switching state to provide the voltage-fed input to the primary-side full bridge.

In another embodiment, the auxiliary power supply includes a low pass filter including first and second smoothing inductors. Both smoothing inductors can be coupled inductors. The first smoothing inductor is connected between the second terminal of the double-throw relay and a first branch of the primary-side full bridge, and the second smoothing inductor is connected between the second terminal of the double throw relay and a second branch of the primary-side full bridge. The auxiliary power supply includes a high-voltage clamp capacitor that is parallel connected to the primary-side full bridge.

In still another embodiment, the auxiliary power module includes a low-voltage clamp capacitor and a secondary-side low pass filter. The clamp capacitor is parallel-connected to the secondary-side full bridge. The low pass filter includes first and second smoothing inductors and a filter capacitor that are connected between the secondary-side full bridge and the output port. The secondary-side of the dual active bridge converter is functionally a combined full bridge and interleaved boost stage. The voltage applied to the high-voltage winding of the step-down transformer is determined by both the input voltage and the primary-side duty cycle when in a voltage-fed mode, whereas the voltage applied to the high-voltage winding of the step-down transformer is determined solely by the input voltage when in a current-fed mode.

These and other features and advantages of the present invention will become apparent from the following description of the invention, when viewed in accordance with the accompanying drawings and the appended claims.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. In addition, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a circuit diagram of a reconfigurable dual active bridge converter for an auxiliary power module in a voltage-fed mode in accordance with one embodiment.

FIG. 2 is a circuit diagram of a reconfigurable dual active bridge converter for an auxiliary power module in a current-fed mode in accordance with one embodiment.

FIG. 3 includes voltage and current waveforms for the reconfigurable dual active bridge converter of FIGS. 1-2.

FIG. 4 includes graphs depicting the high-voltage switching current and the low-voltage switching current as a function of the low-voltage duty cycle.

FIG. 5 includes waveforms for a working example of the reconfigurable current-fed dual active bridge converter at a 600V input voltage and a 16V output voltage.

FIG. 6 includes a graph illustrating the efficiency of the reconfigurable current-fed dual active bridge converter across a wide range of input and output voltages.

FIG. 7 is a circuit diagram of a reconfigurable dual active bridge converter for an auxiliary power module having a low-voltage switch in a voltage-fed mode.

FIG. 8 is a circuit diagram of the reconfigurable dual active bridge converter of FIG. 7 with the low-voltage switch in a current-fed mode.

### DETAILED DESCRIPTION OF THE CURRENT EMBODIMENT

As discussed herein, an auxiliary power module in accordance with one embodiment includes a reconfigurable dual active bridge converter to cover an ultra-wide input and output voltage range. The reconfigurable dual active bridge converter is operable in a voltage-fed mode and a current-fed mode dependent upon the input voltage and/or the output voltage. While described below in relation to an auxiliary power module for an EV, the reconfigurable dual active bridge converter is not limited to EVs and can be used in other applications as desired.

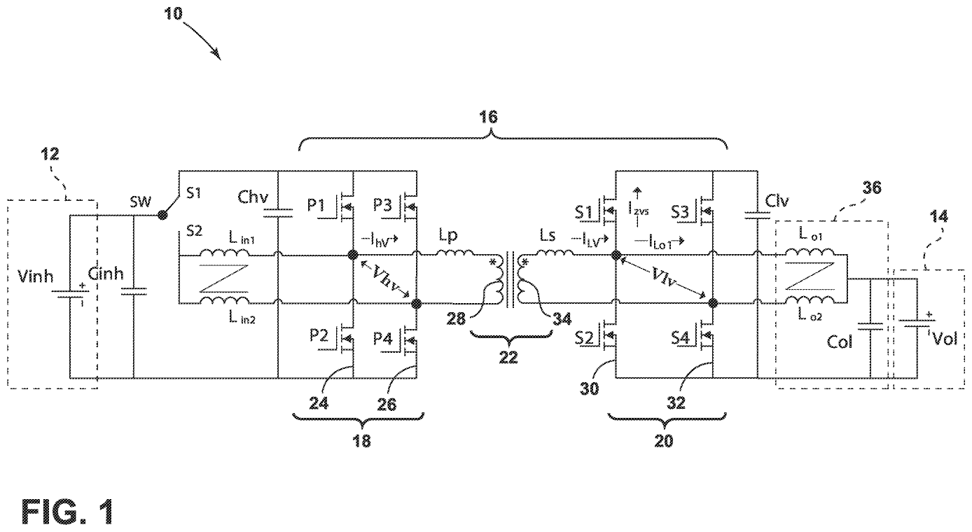

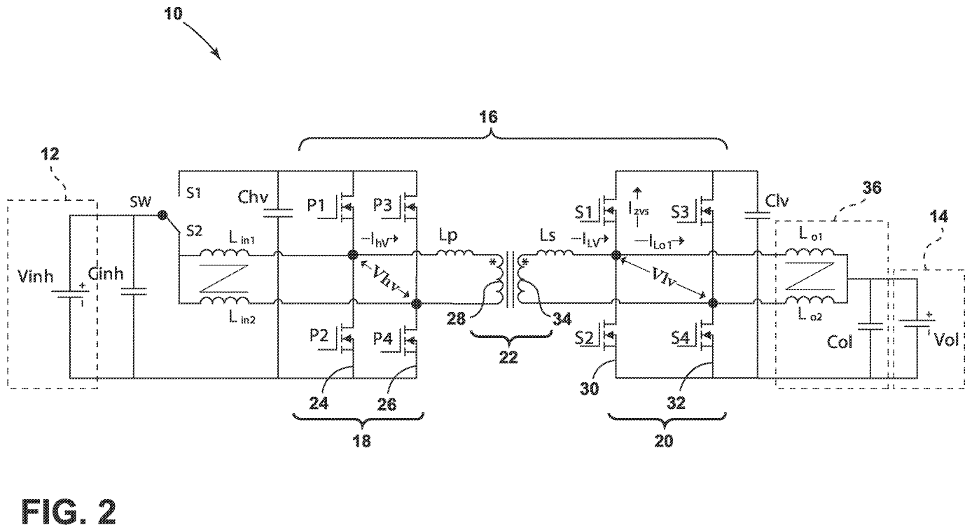

Referring now to FIGS. 1-2, an auxiliary power module is illustrated and generally designated 10. The auxiliary power module 10 includes a high-voltage input port 12, a low-voltage output port 14, and a reconfigurable dual active bridge converter 16 therebetween. The input port 12 is configured to receive a high-voltage DC input from a high-voltage battery, for example an input voltage of between 180V and 900V from a rechargeable lithium-ion battery pack for an EV. The output port 14 is configured to provide a low-voltage DC output to a low-voltage bus, for example an output voltage of between 6V to 20V for charging a low-voltage battery.

The dual active bridge converter 16 includes a primary-side full bridge 18, a secondary-side full bridge 20, and a step-down transformer 22 therebetween. The primary-side full bridge 18 includes switches P1-P4 (distributed along first and second branches 24, 26) and is electrically coupled to the primary-side winding 28 via an inductor Lp. The inductor Lp can be a standalone inductor or the leakage inductance on the transformer primary-side. Similarly, the secondary-side full bridge 20 includes switches S1-S4 (distributed along third and fourth branches 30, 32) and is electrically coupled to the secondary-side winding 34 via an inductor Ls. The inductor Ls can be a standalone inductor or the leakage inductance on the transformer secondary-side. A high-voltage clamp capacitor Chv is parallel connected to the primary-side full bridge 18, and a low-voltage clamp capacitor Clv is parallel connected to the secondary-side full bridge 20. A filter capacitor Cinh is also connected in parallel with the input port 12.

As noted above, the auxiliary power module 10 is operable in a voltage-fed mode and a current-fed mode. To achieve this versatility, the auxiliary power module 10 includes a switch SW connected between the input port 12 and the dual active bridge converter 16. The switch SW is optionally a double-throw relay that connects the input port 12 to a first terminal S1 or to a second terminal S2. When the switch SW connects the input port 12 to the first terminal S1, as shown in FIG. 1, the dual active bridge converter 16 receives a voltage-fed input from the input port 12. When the switch SW connects the input port to the second terminal S2, as shown in FIG. 2, the dual active bridge converter 16 receives a current-fed input from the input port 12.

More specifically, the switch SW can comprise a double-throw relay that is moveable between a first switching state and a second switching state. In a first switching state, the input port 12 is parallel connected to the high-voltage clamp capacitor Chv and the primary-side full bridge 18. In a second switching state, the input port 12 is connected to first and second branches 24, 26 of the primary-side full bridge 18 via first and second smoothing inductors Lin1, Lin2. The first smoothing inductor Lin1 is coupled to a node between series-connected switches P1 and P2, and the second smoothing inductor Lin2 is coupled to a node between series-connected switches P3 and P4.

As noted above, the auxiliary power module 10 integrates a full bridge and an interleaved buck stage. As shown in FIGS. 1-2, a low-voltage clamp capacitor Clv is parallel-connected to the secondary-side full bridge 20. A low pass filter 36 includes first and second smoothing inductors Lo1, Lo2 and a filter capacitor Col coupled between the secondary-side full bridge 20 and the output port 14. The first smoothing inductor Lo1 is electrically connected to the third branch 30 between switches S1 and S2, and the second smoothing inductor Lo1 is electrically connected to the fourth branch 32 between switches S3 and S4.

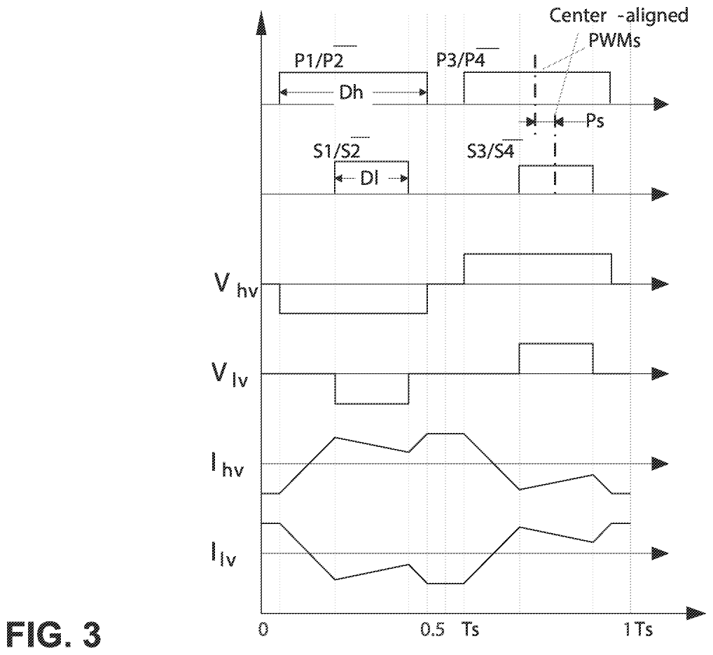

The dual active bridge converter 16 is reconfigurable as either a voltage-fed DC/DC converter or a current-fed DC/DC converter by switching the relay SW to position S1 or S2, respectively. The voltage-fed mode covers the major input and output voltage range, and the current-fed mode can be used for extreme input and output voltages as needed. The output port 14 always operates in a current-fed mode to reduce the RMS current of the transformer's low-voltage winding 34. When the switch SW is in the voltage-fed switching state, as shown in FIG. 1, the voltage applied to the high-voltage winding 28 is determined solely by the input voltage Vinh. When the switch SW is in the current-fed switching state, as shown in FIG. 2, the voltage applied to the high-voltage winding 28 is determined by both of the input voltage Vinh and the primary-side duty cycle Dh. Exemplary voltage waveforms (Vhv, Vlv) and current waveforms (Ihv, Ilv) are shown in FIG. 3. Primary-side duty cycles (Dh) and secondary-side duty cycles (Dl) are also shown in FIG. 3 for the primary-side full bridge 18 and the secondary-side full bridge 20, respectfully. Control of the dual active bridge converter 16 is not limited to the waveforms or duty cycles in FIG. 3 however, which are provided for illustrative purposes and are intended to be non-limiting.

Whether the primary-side full bridge 18 is voltage-fed or current-fed is primarily a function of the input voltage Vinh and the output voltage Vol, which directly determine the zero voltage switching (ZVS) current. When the relay SW is in the first switching state S1, the ZVS current (Izvsₕᵥ) is set forth in equation (1) below, where Nt is the transformer turn ratio and Lp and Ls represent the primary-side and secondary-side leakage inductances, respectively:

$$- {Izvs}_{h v} = - \frac{T * ( N t * Vol - Dh * Vinh )}{2 * ( L p + L s )} \qquad ( 1 )$$

From equation (1) above, zero voltage switching can be guaranteed for a high-voltage duty cycle Dh satisfying equation (2) below, with Dh being physically limited to less than 0.5:

$$Dh > \frac{( N T * Vol )}{Vinh} \qquad ( 2 )$$

The output power Pout is given in equation (3), where Ps represents the time delay between the mid-point of Dh and the mid-point of the Dl, shown in FIG. 3, with Ps being less than Dh−Dl.

$$Pout = \frac{N t * P s * T * Vihn * Vol}{L p + L s} \qquad ( 3 )$$

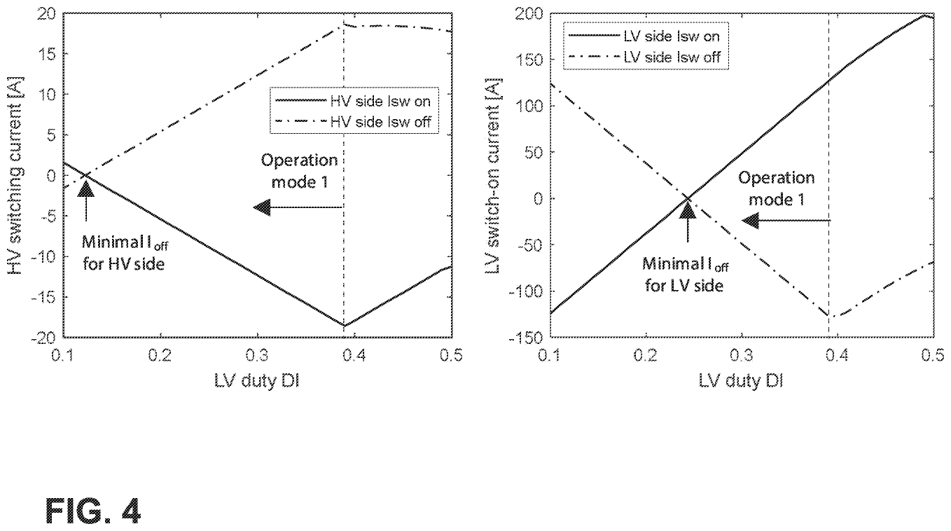

As a result, the power output Pout can be solely controlled by the phase shift generated by a proportional integral (PI) controller. Further, the switching current Ihv can be optimized as a function of the duty cycles Dh and Dl. For example, FIG. 4 plots the high-voltage switching Ihv current as a function of the low-voltage duty cycle Dl and plots the low-voltage switching current Ilv as a function of the low voltage duty cycle Dl, wherein Vinh=700V and Vol=14V. The high-voltage side realizes a minimal switching current at Dl_{opt_hv}=0.11, and the low-voltage side realizes a minimal switching current at Dl_{opt_lv}=0.25. Thus, to achieve minimal overall losses, the optimal duty cycle Dlₒₚₜ is determined by equation (4) below, where Eoff_hv and Eoff_lv are the switching energies of the high-voltage switches (P1-P4) and the low-voltage switches (S1-S4):

$${Dl}_{opt} = \frac{{Dl}_{opt \_ lv} * {E}_{off \_ hv} + {Dl}_{opt \_ hv} * {E}_{off \_ lv}}{{E}_{off \_ hv} + {E}_{off \_ lv}} \qquad ( 4 )$$

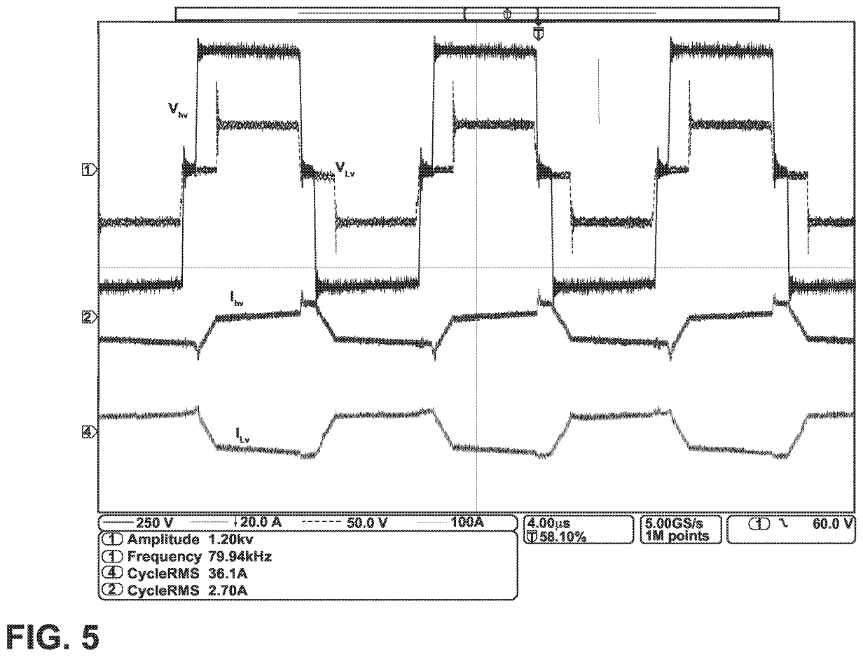

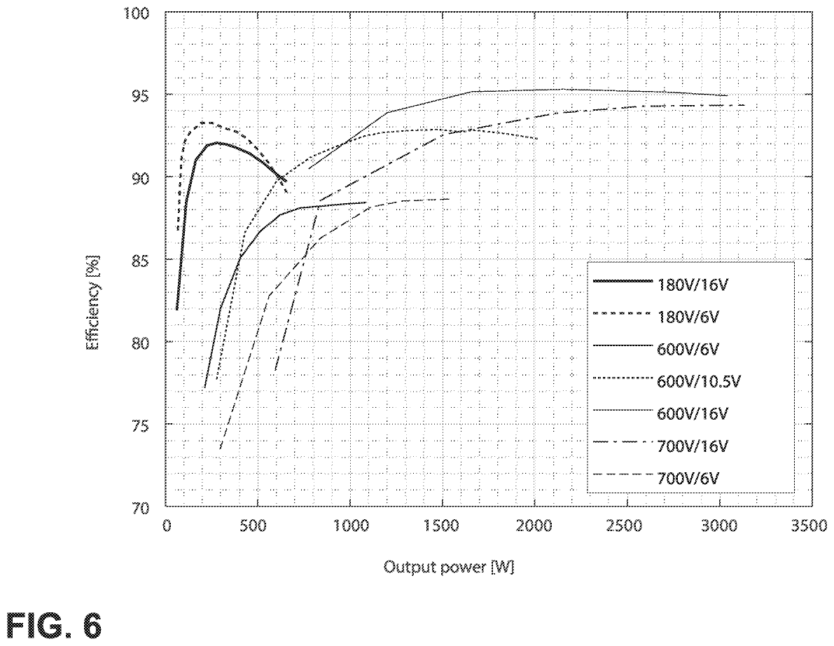

A working example of an auxiliary power supply in accordance with an exemplary embodiment will now be described. The auxiliary power supply included four C3M0032120K SiC switches P1-P4 from Wolfspeed, Inc. (formerly Cree, Inc.) and four IRFF100P219 Si switches S1-S4 from Infinion Technologies AG. The transformer included a turn ration of 12:1. Test results for a 600V input voltage and a 16V output voltage, and efficiency curves at different input and output voltages, are shown in FIGS. 5 and 6, respectively. The tested waveforms (Vhv, Vlv) and switching currents (Ihv, Ilv) showed a strong correlation with computer models, and a peak efficiency of 95.3% was obtained for a 600V input and a 16V output at 3 kW. This working example demonstrated the ability to cover an ultra-wide input and output voltage range, with FIG. 6 depicting input voltages ranging from 180V to 700V and output voltages ranging from 6V to 16V. Input voltages and output voltages outside of these ranges are also possible. The auxiliary power module achieved low switching currents on the low-voltage side and low current stresses at the output port, which reduces losses when compared to conventional topologies.

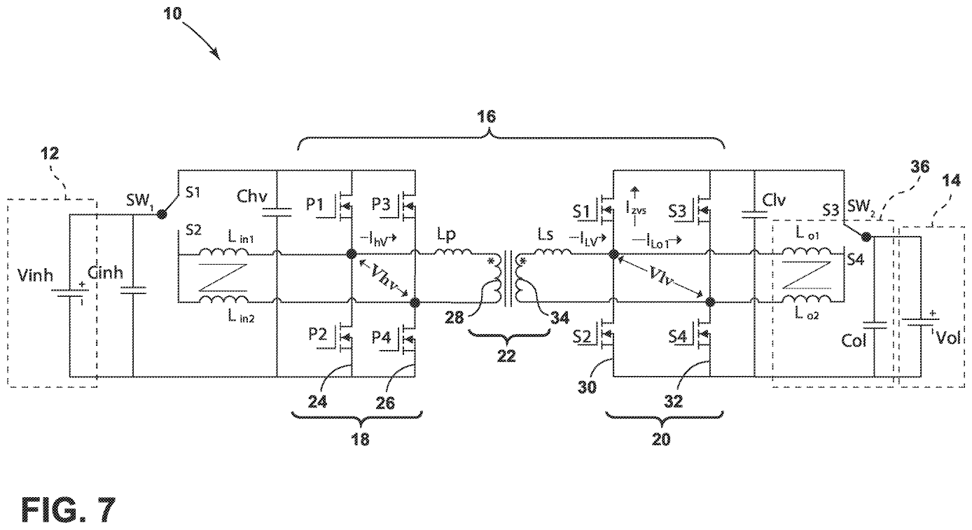

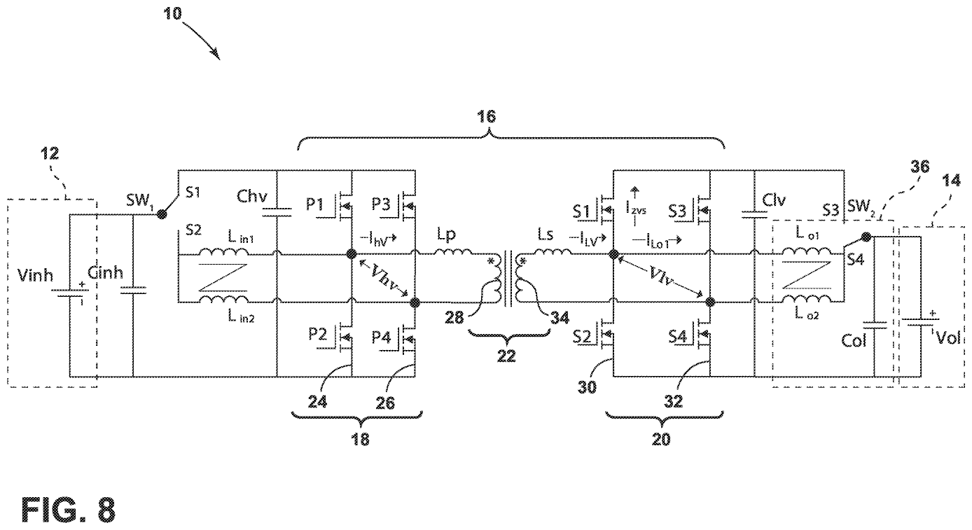

Referring now to FIGS. 7-8, a reconfigurable dual active bridge converter in accordance with a further embodiment is illustrated. The converter of FIGS. 7-8 is similar in structure and in function to the converter of FIGS. 1-2, except that the converter of FIGS. 7-8 includes a low-voltage switch SW₂, in addition to the high-voltage switch SW₁ found in FIGS. 1-2. The low-voltage switch SW₂ is connected between the secondary-side full bridge 20 and the low-voltage output port 14 and provides multiple operating states to the low-voltage output port 14. When the low-voltage switch SW₂ connects the output port 14 to a first terminal S3, as shown in FIG. 7, the output port 14 receives a voltage-fed output. When the low-voltage switch SW₂ connects the output port 14 to a second terminal S4 as shown in FIG. 8, the output port 14 receives a current-fed output. More specifically, the low-voltage switch SW₂ is optionally a double throw relay that is movable between two positions. In the first position as shown in FIG. 7, the low-voltage clamp capacitor Clv is parallel connected to the output port 14, providing a voltage-fed output port with a higher voltage and a lower current. In the second position as shown in FIG. 8, the output port 14 is a current-fed port via the smoothing inductors Lo1, Lo2. In this respect, the output port 14 can provide either of a voltage-fed output or a current-fed output, independent of the position of the high voltage switch SW₁, which as noted above provides either of a voltage-fed input or a current-fed input to the primary-side full bridge 18 of the converter 10.

The above description is that of current embodiments of the invention. While certain features of the putter grip are functional, they can be implemented in different aesthetic configurations. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. An auxiliary power module comprising:
a dual active bridge converter including a primary-side full bridge, a secondary-side full bridge, and a step-down transformer therebetween, the step-down transformer having a first winding electrically connected to the primary-side full bridge and a second winding electrically connected to the secondary-side full bridge;
wherein the primary-side full bridge is electrically connected to an input port and wherein the secondary-side full bridge is electrically connected to an output port, the dual active bridge converter being adapted to convert a high voltage at the input port into a low voltage at the output port; and
wherein the dual active bridge converter further includes a switch electrically connected between the input port and the primary-side full bridge, the switch being moveable between a first switching state and a second switching state, wherein the primary-side full bridge receives a voltage-fed input when the switch is in the first switching state, and wherein the primary-side full bridge receives a current-fed input when the switch is in the second switching state.

2. The auxiliary power module of claim 1, wherein the switch is moveable between the first switching state and the second switching state based on an input voltage at the input port.

3. The auxiliary power module of claim 1, wherein the switch is a double-throw relay that is configured to couple the input port to a first terminal or a second terminal corresponding to the first switching state and the second switching state, respectively.

4. The auxiliary power module of claim 3, wherein the primary-side full bridge is parallel connected to an input voltage at the input port when the switch is in the first switching state.

5. The auxiliary power module of claim 3, further including a primary-side low pass filter including first and second smoothing inductors, the first smoothing inductor connected between the second terminal of the double-throw relay and a first branch of the primary-side full bridge, and the second smoothing inductor connected between the second terminal of the double-throw relay and a second branch of the primary-side full bridge.

6. The auxiliary power module of claim 1, further including: a high-voltage clamp capacitor that is parallel-connected to the primary-side full bridge; and a low-voltage clamp capacitor that is parallel-connected to the secondary-side full bridge.

7. The auxiliary power module of claim 1, further including a secondary-side low pass filter comprising first and second smoothing inductors and a filter capacitor connected between the secondary-side full bridge and the output port.

8. The auxiliary power module of claim 1, wherein the first winding and the second winding each comprise a tank circuit including a standalone inductor.

9. The auxiliary power module of claim 1, wherein the first winding and the second winding each comprise a tank circuit including a leakage inductance.

10. The auxiliary power module of claim 1, wherein the dual active bridge converter is adapted to convert a first DC voltage of between 180V to 900V to a second DC voltage of between 6V and 20V.

11. The auxiliary power module of claim 1, further including a low-voltage switch connected between the secondary-side full bridge and the output port, the low-voltage switch being operable to switch between a voltage-fed output and a current-fed output at the output port.

12. An auxiliary power module comprising:
an input port adapted to be coupled to a first battery of an electric vehicle;
an output port adapted to be coupled to a second battery of an electric vehicle; and
a DC/DC converter electrically connected between the input port and the output port, the DC/DC converter comprising:
a primary-side full bridge,
a secondary-side full bridge,
primary-side smoothing inductors coupled between the input port and the primary-side full bridge,
secondary-side smoothing inductors coupled between the output port and the secondary-side full bridge,
a step-down transformer operably coupled between the primary-side full bridge and the secondary-side full bridge, and
a switch electrically connected between the input port and the primary-side full bridge, the switch being moveable between a first switching state and a second switching state, wherein the primary-side full bridge receives a voltage-fed input from the input port when the switch is in the first switching state and receives a current-fed input from the input port when the switch is in the second switching state.

13. The auxiliary power module of claim 12, wherein the switch is moveable between the first switching state and the second switching state based on an input voltage at the input port.

14. The auxiliary power module of claim 12, wherein the switch is a double-throw relay that is configured to couple the input port to a first terminal or a second terminal corresponding to the first switching state and the second switching state, respectively.

15. The auxiliary power module of claim 14, wherein the primary-side full bridge is parallel connected to an input voltage at the input port when the switch is in the first switching state.

16. The auxiliary power module of claim 14, wherein the primary-side smoothing inductors include a first smoothing inductor connected between the second terminal of the double-throw relay and a first branch of the primary-side full bridge and include a second smoothing inductor connected between the second terminal of the double-throw relay and a second branch of the primary-side full bridge.

17. The auxiliary power module of claim 12, wherein the DC/DC converter further includes a low-pass filter comprising the secondary-side smoothing inductors and a filter capacitor connected between the secondary-side full bridge and the output port.

18. The auxiliary power module of claim 12, further including: a high-voltage clamp capacitor that is parallel-connected to the primary-side full bridge; and a low-voltage clamp capacitor that is parallel-connected to the secondary-side full bridge.

19. The auxiliary power module of claim 12, wherein the transformer includes a first winding electrically connected to the primary-side full bridge and a second winding electrically connected to the secondary-side full bridge, wherein the first winding and the second winding each comprise all or a portion of a tank circuit.

20. The auxiliary power module of claim 12, wherein the primary-side full bridge, the secondary-side full bridge, and the transformer comprise a dual active bridge converter.

21. The auxiliary power module of claim 12, wherein the DC/DC converter is adapted to convert a first voltage of between 180V to 900V to a second voltage between 6V and 20V.

22. The auxiliary power module of claim 12, further including a low-voltage switch connected between the secondary-side full bridge and the output port, the low-voltage switch being operable to switch between a voltage-fed output and a current-fed output at the output port.
